(19) United States
(12) Patent Application Publication
(10) Pub. No.: US 2026/0252563 A1
(43) Pub. Date: Aug. 27, 2026

(54) DEVICE AND METHOD FOR EXTRACTING GRAPH

(71) Applicant: GraphAI Co., Ltd., Daejeon (KR)

(72) Inventors: Jeong Ho PARK, Daejeon (KR); Min Soo KIM, Seongnam-si (KR); Taek Yoon KIM, Anyang-si (KR); In Ju NA, Daejeon (KR)

(73) Assignee: GraphAI Co., Ltd., Daejeon (KR)

(21) Appl. No.: 19/416,000

(22) Filed: Dec. 11, 2025

(30) Foreign Application Priority Data
Feb. 27, 2025 (KR) 10-2025-0026202

(51) Int. Cl. G06F 16/2453

(52) U.S. Cl. CPC G06F 16/24544

(57) ABSTRACT

Provided are a device and method for extracting a graph. The device for extracting a graph performs a plurality of operations including receiving one or more first join queries for extracting a graph from a relational database (RDB), extracting at least one first common subquery included in common in the one or more first join queries, generating at least one first subplan on the basis of the at least one first common subquery, generating a plurality of second subplans by joining a plurality of non-common subqueries included in the at least one first subplan to at least one second common subquery corresponding to the at least one first common subquery, determining a second subplan with a lowest cost as an optimal plan by comparing costs required for executing the plurality of second subplans, and determining the optimal plan as a graph extraction query set.

### CROSS-REFERENCE TO RELATED APPLICATION

This application claims priority to and the benefit of Korean Patent Application No. 10-2025-0026202, filed on Feb. 27, 2025, the disclosure of which is incorporated herein by reference in its entirety.

### BACKGROUND

### 1. Field of the Invention

The present disclosure relates to a device and method for extracting a graph, and more particularly, to a device and method for optimizing an input query and extracting a graph on the basis of the optimized query.

### 2. Discussion of Related Art

Due to technological advancements and the proliferation of digital environment, vast amounts of data are being stored across various industrial fields. Particularly, in fields of social media, finance, e-commerce, biotechnology, artificial intelligence (AI) services, etc., massive amounts of data are continuously accumulating, increasing the necessity of data analysis technologies to effectively utilize this data. In most industrial sectors, data is structured, stored, and managed within relational databases (RDBs). An RDB provides a structured, table-based data storage method, storing individual data attributes and relationships between data in a tabular format. Accordingly, there is increasing necessity for a technology for effectively analyzing RDBs.

In response to this, relational analytics has been developed to analyze data in RDBs at each individual entity level and utilize aggregate operations such as SUM, COUNT, AVG, etc., to identify overall trends in the data. Relational analytics enables the analysis of relationships between several tables through join operations, and is utilized to derive business insights on the basis of this analysis. For example, in various industrial sectors, relational analytics is utilized to perform analyses such as customer segmentation, sales analysis, transaction monitoring, etc., on the basis of RDBs.

However, relational analytics has several limitations in analyzing complex relationships between data. For example, relational analytics has difficulties in analyzing complex patterns within deeply interconnected data.

In particular, in the case of using relational analytics to analyze data relationships such as social network analysis, recommendation systems, etc., it is necessary to join several tables. This process significantly slows down a data processing rate.

Therefore, technology is required for addressing the foregoing issues.

Meanwhile, the above-described related art constitutes technical information either possessed by the inventor in order to deriving the present disclosure or acquired during the process of deriving the present disclosure, and is not necessarily considered prior art disclosed to the general public before the filing date of the present disclosure.

### RELATED ART DOCUMENTS

### Patent Documents

(Patent Document 1) Korean Patent Publication No. 2008-0068035 (Jul. 22, 2008)

### SUMMARY OF THE INVENTION

The present disclosure is directed to providing a graph extraction device and method for providing information required by a user in the form of a graph from vast amounts of data.

The present disclosure is also directed to providing a graph extraction device and method for extracting a graph corresponding to an input query from a relational database (RDB) such that data stored in the RDB may be effectively analyzed.

The present disclosure is also directed to providing a graph extraction device and method for extracting a graph from an RDB and visualizing a complex pattern and complex relationships such that the complex pattern can be effectively analyzed among deeply interconnected data.

The present disclosure is also directed to providing a graph extraction device and method for extracting and providing a graph intended by a user without slowing down a data processing rate.

Objects of the present disclosure are not limited to those described above, and other objects that have not been described will be clearly understood by those of ordinary skill in the art from the following description.

According to an aspect of the present disclosure, there is provided a device for extracting a graph, including at least one memory including a plurality of instructions and at least one processor electrically connected to the at least one memory and configured to execute the plurality of instructions. When the plurality of instructions are executed by the at least one processor, the at least one processor performs a plurality of operations including receiving one or more first join queries for extracting a graph from an RDB, extracting at least one first common subquery included in common in the one or more first join queries, generating at least one first subplan on the basis of the at least one first common subquery, generating a plurality of second subplans by joining a plurality of non-common subqueries included in the at least one first subplan to at least one second common subquery corresponding to the at least one first common subquery, determining a second subplan with a lowest cost as an optimal plan by comparing costs required for executing the plurality of second subplans, and determining the optimal plan as a graph extraction query set.

The at least one second common subquery may include the at least one first common subquery and a materialized view storing a computation result of the at least one first common subquery, and the plurality of second subplans may include a join sharing-outer join query acquired by performing an outer join on the second common subquery and the plurality of non-common subqueries and a join sharing-materialized view query acquired by performing an inner join on the materialized view and the plurality of non-common subqueries.

The generating of the plurality of second subplans may include decomposing the at least one first subplan into the first common subquery and the non-common subqueries, and setting the second common subquery corresponding to the first common subquery as an outer table and performing an outer join on the non-common subqueries and the second common subquery to generate the join sharing-outer join query.

The generating of the plurality of second subplans may include generating the computation result of the first common subquery as the materialized view, electrically storing the materialized view in the at least one memory, and generating the join sharing-materialized view query by performing an inner join on the materialized view and the plurality of non-common subqueries.

The determining of the second subplan with the lowest cost as the optimal plan may include calculating a baseline cost for a baseline subplan solely on the basis of the one or more first join queries, calculating a total sum of a computational cost for the second common subquery, a computational cost for the plurality of non-common subqueries, and a computational cost for the outer join as at least one outer join application cost for each of the second subplans, calculating a total sum of a computational cost for the first common subquery for generating the materialized view, a cost for storing the materialized view in one of the at least one memory, and a computational cost for the join sharing-materialized view query as at least one view join application cost for each of the second subplans, and comparing the baseline cost, the at least one outer join application cost, and the at least one view join application cost to determine a second subplan corresponding to a lowest cost as a first optimal plan.

The plurality of operations may further include updating the first optimal plan with a new baseline subplan, reperforming the extracting of the at least one first common subquery, the generating of the at least one first subplan, the generating of the plurality of second subplans, and the determining of the second subplan with the lowest cost as the optimal plan, on the basis of a query included in the updated baseline subplan, repeating the updating and the reperforming until a second optimal plan derived through the reperforming becomes identical to the baseline subplan, and determining the second optimal plan as the optimal plan that is the graph extraction query set when the baseline subplan is identical to the second optimal plan.

The plurality of operations may further include defining a graph model on the basis of the one or more first join queries and extracting the graph corresponding to the graph extraction query set from the RDB. The graph model may include information on a plurality of vertices and one or more edges defined by the one or more first join queries.

The extracting of the graph may include computing the graph extraction query set from the RDB, extracting the plurality of vertices and the one or more edges from a computation result table of the graph extraction query set, and converting the plurality of extracted vertices and the one or more extracted edges into the graph. The number of types of one or more edges may be equal to the number of one or more first join queries.

The graph may include one or more edges having a pattern of a star structure or a cyclic structure.

According to another aspect of the present disclosure, there is provided a method of extracting a graph by a graph extraction device including at least one memory including a plurality of instructions and at least one processor electrically connected to the at least one memory and configured to execute the plurality of instructions, the method including receiving one or more first join queries for extracting a graph from an RDB, extracting at least one first common subquery included in common in the one or more first join queries, generating at least one first subplan on the basis of the at least one first common subquery, generating a plurality of second subplans by joining a plurality of non-common subqueries included in the at least one first subplan to at least one second common subquery corresponding to the at least one first common subquery, determining a second subplan with a lowest cost as an optimal plan by comparing costs required for executing the plurality of second subplans, and determining the optimal plan as a graph extraction query set.

The at least one second common subquery may include the at least one first common subquery and a materialized view storing a computation result of the at least one first common subquery, and the plurality of second subplans may include a join sharing-outer join query acquired by performing an outer join on the second common subquery and the plurality of non-common subqueries and a join sharing-materialized view query acquired by performing an inner join on the materialized view and the plurality of non-common subqueries.

The generating of the plurality of second subplans may include decomposing the at least one first subplan into the first common subquery and the non-common subqueries, and setting the second common subquery corresponding to the first common subquery as an outer table and performing an outer join on the non-common subqueries and the second common subquery to generate the join sharing-outer join query.

The generating of the plurality of second subplans may include generating the computation result of the first common subquery as the materialized view, electrically storing the materialized view in the at least one memory, and generating the join sharing-materialized view query by performing an inner join on the materialized view and the plurality of non-common subqueries.

The determining of the second subplan with the lowest cost as the optimal plan may include calculating a baseline cost for a baseline subplan solely on the basis of the one or more first join queries, calculating a total sum of a computational cost for the second common subquery, a computational cost for the plurality of non-common subqueries, and a computational cost for the outer join as at least one outer join application cost for each second subplan including the join sharing-outer join query, calculating a total sum of a computational cost for the first common subquery for generating the materialized view, a cost for storing the materialized view in one of the at least one memory, and a computational cost for the join sharing-materialized view query as at least one view join application cost for each second subplan including the join-sharing materialized view query, and comparing the baseline cost, the at least one outer join application cost, and the at least one view join application cost to determine a second subplan corresponding to a lowest cost as a first optimal plan.

The method may further include updating the first optimal plan with a new baseline subplan, reperforming the extracting of the at least one first common subquery, the generating of the at least one first subplan, the generating of the plurality of second subplans, and the determining of the second subplan with the lowest cost as the optimal plan, on the basis of a query included in the updated baseline subplan, repeating the updating and the reperforming until a second optimal plan derived through the reperforming becomes identical to the baseline subplan, and determining the second optimal plan as the optimal plan that is the graph extraction query set when the baseline subplan is identical to the second optimal plan.

The method may further include defining a graph model on the basis of the one or more first join queries and extracting the graph corresponding to the graph extraction query set from the RDB. The graph model may include information on a plurality of vertices and one or more edges defined by the one or more first join queries.

The extracting of the graph may include computing the graph extraction query set from the RDB, extracting the plurality of vertices and the one or more edges from a computation result table of the graph extraction query set, and converting the plurality of extracted vertices and the one or more extracted edges into the graph. The number of types of one or more edges may be equal to the number of one or more first join queries.

The graph may include one or more edges having a pattern of a star structure or a cyclic structure.

According to another aspect of the present disclosure, there is provided a computer program stored in a computer-readable recording medium to perform at least one of the above-described methods in combination with hardware.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of a graph extraction device according to an embodiment of the present disclosure;

FIG. 2 is an illustrative diagram explaining operations of the graph extraction device according to the embodiment of the present disclosure;

FIG. 3 is a listing illustrating a graph model according to the embodiment of the present disclosure;

FIG. 4 is an illustrative diagram explaining a first subplan and a second subplan according to the embodiment of the present disclosure;

FIG. 5 is an illustrative diagram explaining an operation of generating a join sharing-outer join query according to the embodiment of the present disclosure;

FIG. 6 is an illustrative diagram explaining an operation of generating a join sharing-materialized view query according to the embodiment of the present disclosure;

FIG. 7 is an illustrative diagram explaining an operation of determining an optimal plan according to the embodiment of the present disclosure;

FIG. 8 is an illustrative diagram explaining an operation of extracting a graph according to the embodiment of the present disclosure;

FIG. 9 is a set of graphs illustrating the performance of the graph extraction device according to the embodiment of the present disclosure on the basis of a recommendation system model of a transaction processing performance council decision support (TPC-DS) dataset;

FIG. 10 is a table illustrating the performance of the graph extraction device according to the embodiment of the present disclosure on the basis of a database systems and logic programming (DBLP) dataset and an Internet movie database (IMDB) dataset;

FIG. 11 is a graph illustrating stage-specific performance of the graph extraction device according to the embodiment of the present disclosure based on a query optimization operation;

FIG. 12 is a flowchart illustrating a graph extraction method according to an embodiment of the present disclosure;

FIG. 13 is a flowchart illustrating an optimal plan determination method according to an embodiment of the present disclosure; and

FIG. 14 is a flowchart illustrating additional operations of a graph extraction method according to another embodiment of the present disclosure.

### DETAILED DESCRIPTION OF EXEMPLARY EMBODIMENTS

Advantages and features of the present disclosure and methods of achieving them will become apparent with reference to embodiments described in detail below in conjunction with the accompanying drawings. However, the present disclosure is not limited to the embodiments disclosed below but may be implemented in various different forms, and the embodiments are only provided to make the disclosure of the present disclosure complete and fully convey the scope of the present disclosure to those of ordinary skill in the art to which the present disclosure pertains. The present disclosure is only defined by the scope of claims.

The shape, size, ratio, angle, number, etc., shown in the drawings to describe embodiments of the present disclosure are merely illustrative, and the present disclosure is not limited to those shown in the drawings. In describing the present disclosure, when detailed description of a related known technology is determined to unnecessarily obscure the subject matter of the present disclosure, the detailed description will be omitted. When terms such as “including,” “having,” “comprising,” etc., are used throughout the specification, an additional component may be present unless “only” is used. A component described in a singular form encompasses a plurality thereof unless particularly stated otherwise.

Components are construed as including an error range even when there is no additional particular description.

Although terms such as “first,” “second,” etc., are used to describe various components, the components are not limited by these terms. The terms are merely used to distinguish one component from others. Accordingly, in the following description, a first component may be a second component within the technical spirit of the present disclosure.

Throughout the specification, the same reference numerals refer to the same components unless particularly specified otherwise.

Features of various embodiments of the present disclosure may be partially or completely coupled to or combined with each other, and various interoperations and operations are technically possible as those of ordinary skill in the art readily understand. Embodiments may be implemented independently from each other or may be implemented together in an interrelated manner.

Hereinafter, the present disclosure will be described in detail with reference to the accompanying drawings.

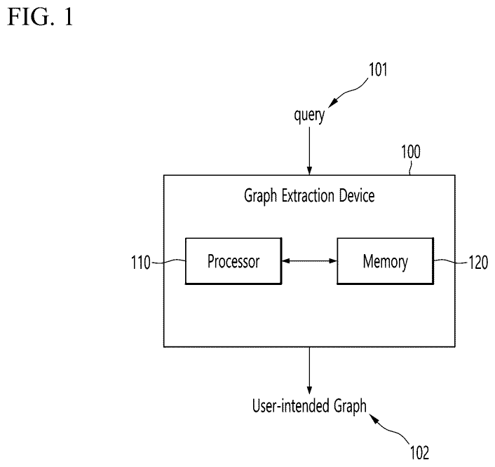

FIG. 1 is a block diagram of a graph extraction device according to an embodiment of the present disclosure.

Referring to FIG. 1, a graph extraction device 100 includes at least one processor 110 and at least one memory 120. In some cases, the graph extraction device 100 may further include a disk drive (not shown).

The graph extraction device 100 may be a device that receives a query 101 and outputs a graph 102. Specifically, the graph extraction device 100 may be a device that extracts the graph 102 corresponding to the query 101 from a relational database (RDB).

The graph extraction device 100 may be included in various electronic devices. For example, the graph extraction device 100 may be included in a personal computer (PC), a data server, or a portable device.

The at least one processor 110 may be a data processing device that is implemented as hardware with circuitry having a physical structure for performing desired operations. Here, the desired operations may include code or instructions included in a program. For example, the processor 110 implemented as hardware may include a microprocessor, a central processing unit (CPU), a processor core, a multi-core processor, a multiprocessor, an application-specific integrated circuit (ASIC), and a field programmable gate array (FPGA).

The at least one memory 120 may include a volatile memory device or a non-volatile memory device. For example, the at least one memory 120 may include at least one of non-volatile memory devices such as an electrically erasable programmable read-only memory (EEPROM), a flash memory, and a magnetic random access memory (MRAM), and volatile memory devices such as a dynamic RAM (DRAM), a static RAM (SRAM), a thyristor (T)-RAM, a zero capacitor RAM (Z-RAM), and a twin transistor RAM (TTRAM).

The at least one memory 120 may store computer-readable code (e.g., software) and a plurality of instructions. Also, the at least one memory 120 may include data required for processing operations of the processor 110 or data calculated from query operations. In some cases, the at least one memory 120 may store the RDB.

The processor 110 may be electrically connected to the memory 120 and process data stored in the memory 120. Specifically, the at least one processor 110 may execute the computer-readable code and instructions stored in the memory 120. For example, the processor 110 may perform a series of operations from an operation of receiving the query 101 to an operation of outputting the graph 102, by executing the plurality of instructions stored in the memory 120. In other words, operations performed by the graph extraction device 100 may be practically performed by the processor 110 executing the plurality of instructions stored in the memory 120.

The disk drive (not shown) may be a non-volatile mass storage device. For example, the disk drive may include at least one of a hard disk drive (HDD) and a solid state drive (SSD). The disk drive (not shown) may temporarily or permanently store program code and settings for controlling the graph extraction device 100, database table information, join graph information, a cost model, and a query optimization plan.

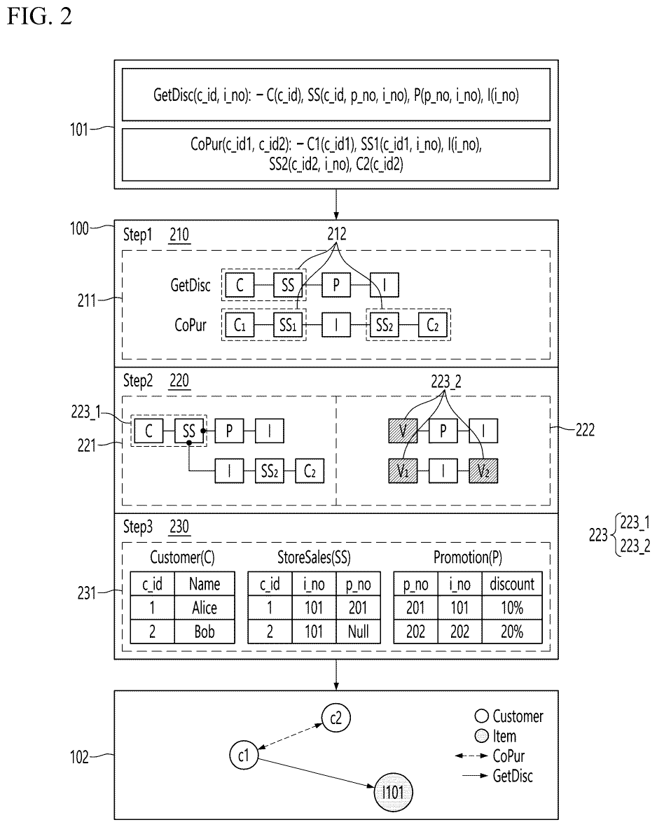

FIG. 2 is an illustrative diagram explaining operations of the graph extraction device according to the embodiment of the present disclosure.

Referring to FIG. 2, the graph extraction device 100 may perform operations of three steps 210, 220, and 230. Specifically, the graph extraction device 100 may perform operations of the three steps 210, 220, and 230 as operations of extracting the graph 102 on the basis of the received query 101.

The query 101 may be query information about a graph to be extracted. Specifically, the query 101 may include information on vertices, edges, and properties of the graph to be extracted. For example, the query 101 may include the definitions of an edge GetDisc between a customer C who receives a discount and a discounted item I and an edge CoPur between customers C who purchases the same item I.

The query 101 may include at least one join query. For example, the query 101 may include a GetDisc join query and a CoPur join query. Each join query may include information about a label of an edge to be extracted, a label of a source vertex of the edge, a label of a destination vertex of the edge, tables on which an inner-join will be performed, and a join condition between tables. Specifically, the GetDisc join query may include information of an edge label: GetDisc, a label of a source vertex: Customer, a label of a destination vertex: Item, tables on which an inner join will be performed: Customer(C1), StoreSales(SS1), Item(I), StoreSales(SS2), and Customer(C2), and join conditions: C1.c_id=SS1.c_id AND I.i_no=SS.i_no AND P.p_no=SS.p_no AND I.i_no=P.i_no.

The query 101 may be a query in various languages. For example, the query 101 may include a structured query language (SQL) query, a view definition language (VDL) query, and a graph query. Preferably, the query 101 is an SQL query.

The graph 102 may be a graph corresponding to the query 101. Specifically, the graph 102 may be a graph that visualizes tuples satisfying the conditions included in the query 101 as vertices and edges. For example, the graph 102 may be a graph showing a vertex c1, a vertex I101, and a GetDisc edge satisfying the GetDisc join query of the query 101 and the vertex c1, a vertex c2, and a CoPur edge satisfying the CoPur join query of the query 101.

The graph 102 may be a user-intended graph. Specifically, the graph 102 may be a graph composed of vertices and edges requested by a user through the query 101. More specifically, the graph 102 may be a graph that does not include virtual vertices or virtual edges but is solely composed of edges defined by the query 101 and source vertices and destination vertices of the edges. For example, when the query 101 only includes the GetDisc join query and the CoPur join query, the graph 102 may be solely composed of at least one GetDisc edge, a source vertex and a destination vertex of the GetDisc edge, at least one CoPur edge, and a source vertex and a destination vertex of the CoPur edge. Accordingly, the graph 102 can accurately and intuitively show a graph to be analyzed by the user. When a virtual vertex and a virtual edge are included in an extracted graph, it is necessary to perform a multi-hop search upon each single-hop search during a graph analysis process, which may increase the time and cost for graph analysis. The graph 102 according to the embodiment of the present disclosure is solely composed of the edges defined by the query 101 without unnecessary vertices and edges, improving graph analysis efficiency and reducing the time and cost required for graph analysis.

The graph 102 may include various edge shapes. For example, the graph 102 may include a chain edge shape, a star edge shape, or a cyclic edge shape. In some cases, the graph 102 may include at least one of a star edge shape and a cyclic edge shape. Since the graph 102 according to the embodiment of the present disclosure includes various graph structures, it is possible to extend the application range of graph analysis based on an extracted graph.

The graph extraction device 100 may process the query 101 and extract the graph 102 as a query result corresponding to the query 101. Specifically, the graph extraction device 100 may perform an operation of receiving the query 101 for extracting the graph 102 from an RDB 231, an operation of optimizing the received query 101, and an operation of computing the optimized query 101 and extracting the graph 102 from the RDB 231.

Referring to FIG. 2, the operation of optimizing the received query 101 may include a first step 210 and a second step 220. The first step 210 may include an operation of extracting a first common query 212 that is included in common in at least one join query included in the query 101. For example, in the first step 210, the graph extraction device 100 may extract, as first common subqueries 212, a Customer-StoreSales join that is included in common in a GetDisc join query and a CoPur join query. In some cases, the graph extraction device 100 may extract a plurality of different first common subqueries 212 from the query 101.

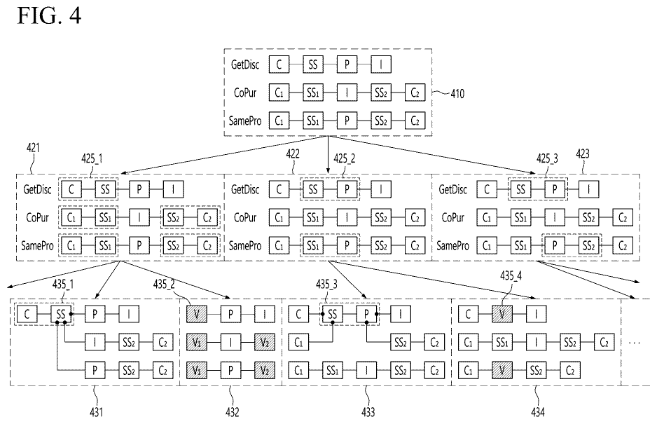

The graph extraction device 100 may generate a query optimization plan on the basis of the one or more extracted first common subqueries 212. Specifically, the graph extraction device 100 may generate a first subplan 211 based on each of the extracted first common subqueries 212. The first subplan 211 will be described in detail below with reference to FIG. 4.

The second step 220 may include an operation of generating second subplans 221 and 222 for the first subplan 211. Specifically, in the second step 220, the graph extraction device 100 may generate the plurality of second subplans 221 and 222 by joining non-common subqueries included in the first subplan 211 to a second common subquery 223. The second common subquery 223 may be subqueries corresponding to the first common subqueries 212. Specifically, one or more second common subqueries 223_1 and 223_2 may include the one or more first common subqueries 212 and a materialized view V storing computation results of the one or more first common subqueries 212. For example, the second common subquery 223_1 included in the 1^{st} second subplan 221 may be a shared subquery which is identical to the first common subqueries 212, and the second common subquery 223_2 included in the 2^{nd} second subplan 222 may be the materialized view V storing the computation result of the first common subqueries 212. The second subplans 221 and 222 will be described in detail below with reference to FIGS. 4 to 6.

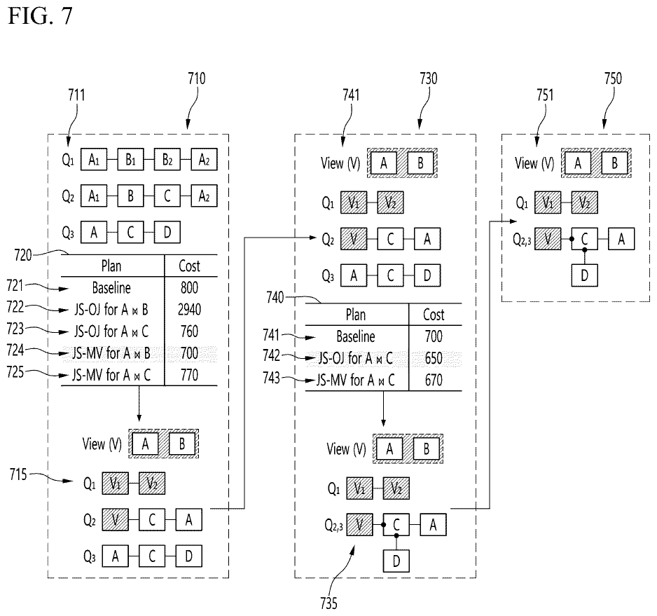

The second step 220 may include an operation of determining a second subplan with the lowest cost as an optimal plan by comparing costs required for executing the plurality of second subplans 221 and 222, and determining the optimal plan as a graph extraction query set. The operation of determining the second subplan with the lowest cost as an optimal plan and the operation of determining the optimal plan as a graph extraction query set may be described in detail below with reference to FIG. 7.

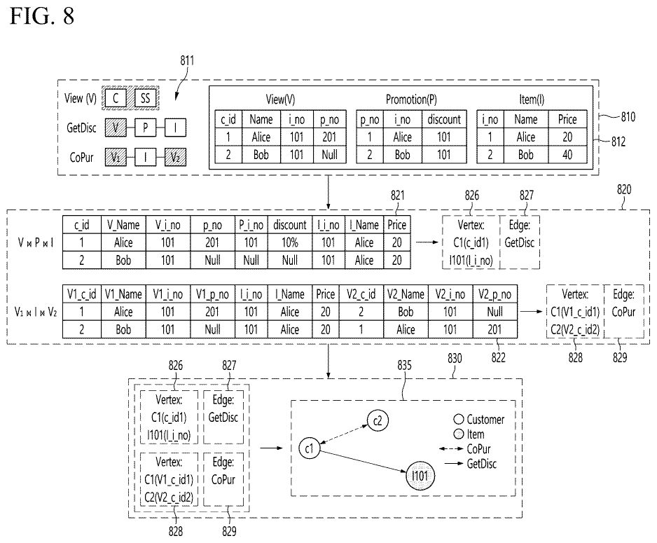

The third step 230 may include an operation of extracting the graph 102 corresponding to the graph extraction query set from the RDB 231. Specifically, in the third step 230, the graph extraction device 100 may perform an operation of computing the graph extraction query set from the RDB 231 and converting the computation results into the graph 102. The operation of extracting a graph will be described in detail below with reference to FIG. 8.

The RDB 231 is a type of DB that stores and manages data in a standardized table form. The RDB 231 may be a set of correlated tables. Specifically, tables included in the RDB 231 are independent data units but may be connected to each other by utilizing a foreign key.

The RDB 231 may include rows, columns, a primary key, and a foreign key. Each row may represent one data item and correspond to one entity and tuple (instance) in the table. Referring to FIG. 2, the RDB 231 may include a Customer (C) table, a StoreSales (SS) table, and a Promotion (P) table each including two tuples. Columns represent specific attributes of data and may define the structure of a table. For example, the Customer (C) table stored in the RDB 231 may include a customer identifier (ID) column c_id and a name column Name, and the StoreSales (SS) table may include a customer ID column c_id, an item number column i_no, and a promotion number column p_no. The primary key may be an attribute for uniquely identifying each row. For example, a primary key of the Customer (C) table may be the customer ID column c_id. The foreign key may be an attribute that one table references to indicate a relationship with another table.

The RDB 231 may be stored in the disk drive (not shown). Specifically, data files of the RDB 231 may be stored in the disk drive. For example, data files of the RDB 231 may be stored in at least one of the HDD and SSD. In some cases, the RDB 231 may be stored in at least one of the at least one memory 120. Specifically, the RDB 231 may be stored in at least one of the at least one memory 120 in a volatile or non-volatile manner. For example, the RDB 231 may be a relational database management system (RDBMS) based on the memory 120. According to various embodiments of the present disclosure, the RDB 231 may be hybrid RDB that is stored in the disk drive and the at least one memory 120 in a distributed manner.

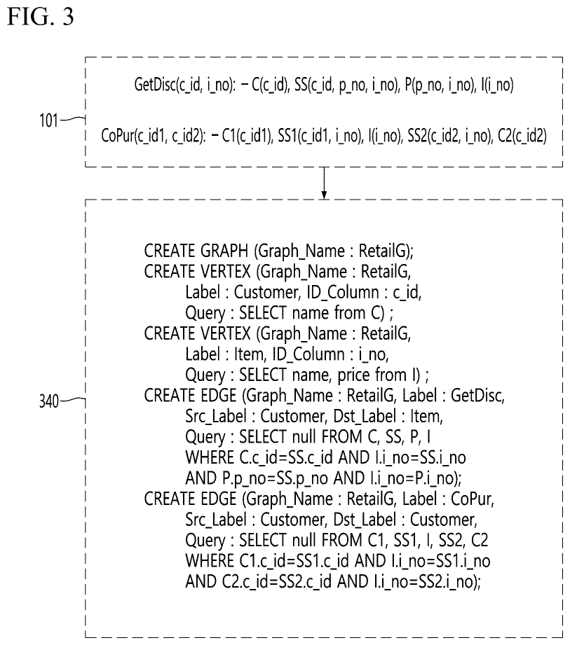

FIG. 3 is a listing illustrating a graph model according to the embodiment of the present disclosure.

Referring to FIG. 3, the graph extraction device 100 may perform an operation of defining a graph model 340 on the basis of at least one join query included in the query 101. Specifically, the graph extraction device 100 may generate the graph model 340 including information on a plurality of vertices and one or more edges defined by the query 101.

Referring to FIGS. 2 and 3, the graph model 340 may include information on the graph 102 to be generated in response to the received query 101. For example, the graph model 340 may define vertices and edges constituting a graph by including a graph name Graph_Name, information on the vertices to be included in the graph, and information on the edges to be included in the graph.

The information on the vertices to be included in the graph includes information on labels Label of the vertices, a primary key ID_Column of a vertex table, and the Name column of the Customer (C) table such that tables and attributes required for extracting the graph from the RDB may be defined. The information on the edges to be included in the graph includes information on labels Label of the edges, labels Src_Label of source vertices of the edges, labels Dst_Label of destination vertices of the edges, tables FROM to be joined, and join conditions WHERE such that tables, attributes, and join conditions required for extracting the graph from the RDB may be defined. Accordingly, the graph extraction device 100 may previously select tables and attributes required for extracting the graph by generating the graph model 340 in advance on the basis of the received query 101.

Therefore, the graph extraction device 100 according to the embodiment of the present disclosure can minimize unnecessary computations and reduce the load on an RDB by previously selecting tables and attributes required for graph extraction within the RDB. Also, before performing a query optimization operation, the graph extraction device 100 previously selects tables and attributes of vertices and edges required for query optimization and graph extraction through a graph model and thus can efficiently search an RDB for the selected data and load the selected data onto an in-memory. Accordingly, the graph extraction device 100 directly processes the data loaded onto the in-memory in an optimization operation and then can minimize unnecessary database accesses and increase graph extraction and query optimization speeds in the optimization operation.

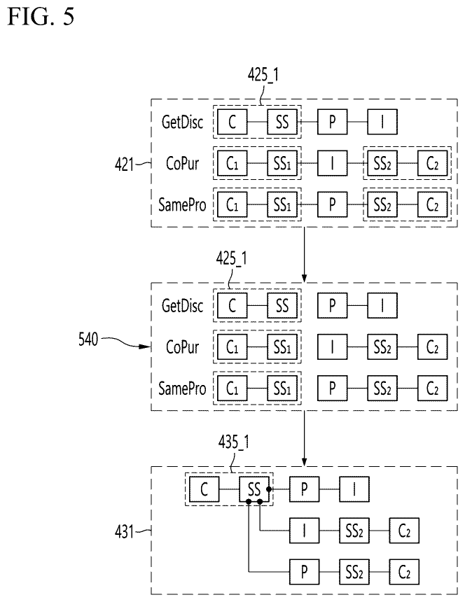

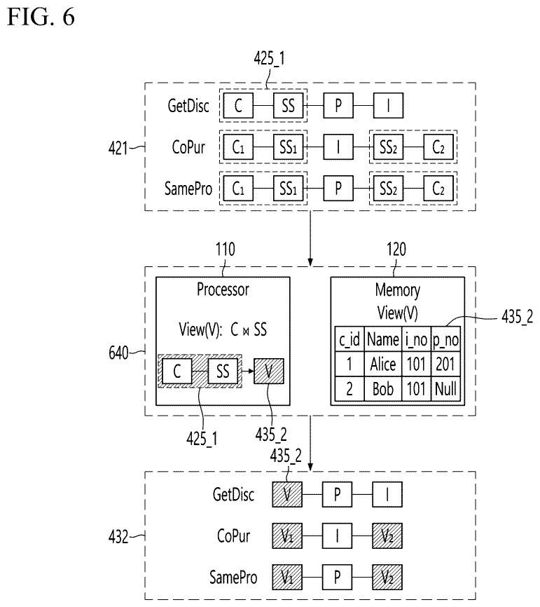

FIG. 4 is an illustrative diagram explaining a first subplan and a second subplan according to the embodiment of the present disclosure. FIG. 5 is an illustrative diagram explaining an operation of generating a join sharing-outer join query according to the embodiment of the present disclosure. FIG. 6 is an illustrative diagram explaining an operation of generating a join sharing-materialized view query according to the embodiment of the present disclosure.

Referring to FIGS. 4 to 6, the graph extraction device 100 may perform an operation of generating first subplans 421, 422, and 423 on the basis of a plurality of join queries 410 included in the received query 101 and an operation of generating second subplans 431, 432, 433, and 434 on the basis of the first subplans 421, 422, and 423.

The operation of generating the first subplans 421, 422, and 423 may include an operation in which the graph extraction device 100 extracts at least one first common subquery 425 included in common in the plurality of join queries 410 and an operation in which the graph extraction device 100 generates the one or more first subplans 421, 422, and 423 on the basis of the first common subquery 425. Specifically, the operation of generating the first subplans 421, 422, and 423 may include an operation of generating various cases where the graph extraction device 100 may extract the first common subquery 425 from the plurality of join queries 410, as the first subplans 421, 422, and 423. More specifically, the operation of generating the first subplans 421, 422, and 423 may include an operation of generating all the cases where the graph extraction device 100 may extract the first common subquery 425 from the plurality of join queries 410, as the first subplans 421, 422, and 423. For example, the graph extraction device 100 may extract first common subqueries 425_1 including a C-SS join and first common subqueries 425_2 and 425_3 including an SS-P join from the plurality of join queries 410 through the operation of generating the first subplans 421, 422, and 423.

The operation of generating the second subplans 431, 432, 433, and 434 may include an operation in which the graph extraction device 100 joins non-common subqueries included in the one or more first subplans 421, 422, and 423 to a second common subquery 435. Specifically, the operation of generating the second subplans 431, 432, 433, and 434 may include an operation in which the graph extraction device 100 joins the second common subquery 435 and a non-common subquery to each of the first subplans 421, 422, and 423. Here, the second common subquery 435 may be subqueries 435_1 and 435_3 that are identical to the first common subquery 425 or materialized views 435_2 and 435_4 that store a computation result of the first common subquery 425. For example, the 1^{st} second subplan 431 may include a join sharing-outer join query acquired by performing an outer join on the 1^{st} second common subquery 435_1 which is identical to the 1^{st} first common subqueries 425_1 and non-common subqueries of the 1^{st} first subplan 421. The 2^{nd} second subplan 432 may include join sharing-materialized view queries acquired by performing an inner join on materialized views V storing computation results of the 2^{nd} first common subqueries 425_2 and non-common subqueries of the 2^{nd} first subplan 422.

Referring to FIGS. 4 and 5, an operation of generating the 1^{st} second subplan 431 including the join sharing-outer join query may include an operation 540 in which the graph extraction device 100 decomposes the 1^{st} first subplan 421 and an operation in which the graph extraction device 100 performs an outer join on the 1^{st} second common query 435_1. Specifically, the graph extraction device 100 may perform an operation of decomposing the 1^{st} first subplan 421 into the 1^{st} first common subqueries 425_1 and a non-common subquery and an operation of setting the 1^{st} second common subquery 435_1 which is identical to the 1^{st} first common subqueries 425_1 as an outer table and performing an outer join on the non-common subquery of the 1^{st} first subplan 421 and the 1^{st} second common subquery 435_1. An operation of generating the plurality of second subplans 431 and 433 including a join sharing-outer join query may be substantially the same as an operation of generating the 1^{st} second subplan 431.

For this reason, the graph extraction device 100 may prevent the interference between join operations by connecting the second common subquery 435 and a non-common subquery using an outer join. Therefore, the graph extraction device 100 sets the second common subquery 435 as an outer table and performs an outer join on the second common subquery 435 and the non-common subquery, thereby calculating results identical to those obtained by individually processing GetDisc, Copur, and SamePro join queries. Accordingly, the graph extraction device 100 according to the embodiment of the present disclosure can reduce the time and cost required for computing the plurality of join queries 410 while calculating results identical to those obtained by individually computing the plurality of join queries 410.

Referring to FIGS. 4 and 6, an operation of generating the 2^{nd} second subplan 432 including the join sharing-materialized view query may include an operation 640 in which the graph extraction device 100 stores a computation result of the 1^{st} first common subqueries 425_1 as materialized views (V) 435_2 and an operation in which the graph extraction device 100 generates the 2^{nd} second subplan 432 by performing an inner join on the materialized views (V) 435_2 and the non-common subqueries of the 1^{st} first subplan 421. Specifically, the operation 640 of storing the computation results of the 1^{st} first common subqueries 425_1 as the materialized views (V) 435_2 may include an operation in which the graph extraction device 100 generates the computation results of the 1^{st} first common subqueries 425_1 as the materialized views V and an operation in which the graph extraction device 100 electrically stores the materialized view V in the disk drive or the at least one memory 120. For example, the processor 110 of the graph extraction device 100 may perform an operation of generating computation results of Customer-StoreSales inner joins included in the 1^{st} first common subqueries 425_1 as the materialized views V and storing the materialized views V in the memory 120 as the 2^{nd} second common subquery 435_2. In other words, an operation of generating the 2^{nd} second subplan 432 including the join sharing-materialized view query may be an operation of substituting each of the 1^{st} first common subqueries 425_1 with the materialized views V storing the computation results of the 1^{st} first common subqueries 425_1. An operation of generating the plurality of second subplans 432 and 434 including a join sharing-materialized view query may be substantially the same as an operation of generating the 2^{nd} second subplan 432.

The graph extraction device 100 may store the materialized views V in a physical storage device such as the disk drive or the at least one memory 120. In other words, the graph extraction device 100 may store the materialized views V in the disk drive such as the HDD and SSD, or at least one of the at least one memory 120. In some cases, the graph extraction device 100 may store the materialized views V in the disk drive and the at least one memory 120 in a distributed manner. For example, the graph extraction device 100 may store the materialized views V in the disk drive in which data files of the RDB are stored, or a separate disk drive from the disk drive in which the data files of the RDB are stored.

Accordingly, the graph extraction device 100 according to the embodiment of the present disclosure can reduce repetitive and unnecessary computations by storing a computation result of a repeated common subquery as a materialized view. Therefore, the graph extraction device 100 can reduce the load on the graph extraction device 100 and a DB server by reducing the usage of the CPU and memory used for unnecessary computations. Also, the graph extraction device 100 can efficiently reduce costs required for storing or retrieving materialized views by storing a computation result of a common subquery that requires repetitive processing as a materialized view. Consequently, the graph extraction device 100 can efficiently optimize received queries.

FIG. 7 is an illustrative diagram explaining an operation of determining an optimal plan according to the embodiment of the present disclosure.

Referring to FIG. 7, the graph extraction device 100 may compare costs required for executing the plurality of second subplans, performing an operation 710 of determining a second subplan with the lowest cost as an optimal plan and an operation 750 of determining the determined optimal plan as a graph extraction query set 751. According to various embodiments of the present disclosure, the graph extraction device 100 may further perform an operation 730 of reperforming the operation of updating a determined first optimal plan 715 with a baseline subplan 741 and determining a second optimal plan 735 for the baseline subplan 741.

The operation 710 of determining the second subplan with the lowest cost as the first optimal plan 715 may include an operation of generating a first cost model 720 including a baseline cost for a baseline subplan 721 and costs for second subplans 722, 723, 724, and 725 and an operation of determining a subplan with the lowest cost in the first cost model 720 as the first optimal plan 715. The baseline subplan 721 may be a subplan solely composed of one or more join queries 711 included in the query received by the graph extraction device 100.

The operation of generating the first cost model 720 may include an operation of calculating a baseline cost for the baseline subplan 721, an operation of calculating a total sum of a computational cost for the second common subquery, computational costs for the plurality of non-common subqueries, and a computational cost for the outer join as at least one outer join application cost for each of the second subplans 722 and 723 including a join sharing-outer join (JS-OJ) query, an operation of calculating a total sum of computational costs for the first common subqueries for generating a materialized view, costs for storing materialized views in the memory 120 or disk, and a computational cost for the join sharing-materialized view (JS-MV) query as a view join application cost for each of the second subplans 724 and 725 including the join sharing-materialized view (JS-MV) query.

Specifically, the operation of calculating the baseline cost for the baseline subplan 721 may be an operation of calculating a total sum of computational costs for the one or more join queries 711. For example, when all the one or more join queries 711 follow a left-deep plan of binary joins and a hash join method, the baseline cost may be calculated as a total sum of a probe cost for the leftmost table (table A) and hash table building costs for other tables. In the operation of calculating the outer join application cost, an operation of calculating the computational cost for the second common subquery and the computational costs for the non-common subqueries may be substantially the same as an operation of calculating the computational costs for the one or more join queries 711. An operation of calculating the computational cost for the outer join may include an operation of calculating a total sum of a probe cost for the second common subquery and hash table building costs for the non-common subqueries when the outer join is a hash join.

In the operation of calculating the view join application costs, an operation of calculating the computational costs for the first common subqueries and the computational cost for the join sharing-materialized view (JS-MV) query may be substantially the same as the operation of calculating the computational costs for the one or more join queries 711. The operation of calculating the costs for storing the materialized views in the disk may include the calculation of multiplying the number of disk pages in which the materialized views are stored by a cost required for accessing one disk page.

The operation of determining the subplan with the lowest cost in the first cost model 720 as the first optimal plan 715 may include an operation of determining a second subplan with the lowest cost as the first optimal plan 715 by comparing the baseline cost included in the first cost model 720, the at least one outer join application cost, and the one or more view join application costs.

Accordingly, the graph extraction device 100 may generate the first cost model 720 including the baseline cost for the baseline subplan 721 and cost information of each of the second subplans 722, 723, 724, and 725 and compare the cost information with each other, deriving the first optimal plan 715 with the lowest cost among the various subplans. Therefore, the graph extraction device 100 can reduce a cost required for graph extraction by always deriving an optimized plan that requires the lowest cost. Also, in some cases, even when a cost required for computing a join sharing-outer join (JS-OJ) query or a join sharing-materialized view (JS-MV) query increases beyond the baseline cost or decreases slightly, the graph extraction device 100 can improve the efficiency of a query optimization operation by deriving an optimized plan requiring the lowest cost. In other words, the graph extraction device 100 can determine a plan for minimizing a cost required for executing a query by selecting at least one of the join sharing-outer join (JS-OJ) query and the join sharing-materialized view (JS-MV) query or combining the queries.

According to various embodiments of the present disclosure, the graph extraction device 100 may determine the first optimal plan 715 as the graph extraction query set 751 through the operation 710 of determining the second subplan with the lowest cost as the first optimal plan 715 and an operation 750 of determining the determined optimal plan as the graph extraction query set 751. In other words, the graph extraction query set 751 may be the first optimal plan 715 including only one of the join sharing-outer join (JS-OJ) query and the join sharing-materialized view (JS-MV) query. Accordingly, when the one or more join queries 711 include relatively simple join queries, the graph extraction device 100 involves less cost and time for an operation of optimizing a query, and thus it is possible to rapidly derive a graph extraction query set at a low cost.

In addition, the graph extraction device 100 may further perform the operation 730 of reperforming the operation of updating the first optimal plan 715 which is determined through the operation 710 of determining the second subplan with the lowest cost as the first optimal plan 715, with the baseline subplan 741 and determining the second optimal plan 735 for the baseline subplan 741. Specifically, the graph extraction device 100 may further perform an operation of updating the first optimal plan 715 with the new baseline subplan 741 and an operation of reperforming the operation of extracting the one or more first common subqueries, the operation of generating the one or more first subplans, the operation of generating the plurality of second subplans 742 and 743, and the operation of determining the second subplan with the lowest cost as the second optimal plan 735, on the basis of a query included in the updated baseline subplan 741. The operation of extracting the one or more first common subqueries, the operation of generating the one or more first subplans, and the operation of generating the plurality of second subplans 742 and 743 may be performed in substantially the same way as the operation of extracting the first common subqueries 425, the operation of generating the first subplans 421, 422, and 423, and the operation of generating the second subplans 431, 432, 433, and 434 of FIGS. 4 to 7. Also, the operation of determining the second subplan with the lowest cost as the second optimal plan 735 may be substantially the same as the operation 710 of determining the second subplan with the lowest cost as the first optimal plan 715 in FIG. 7.

For example, the graph extraction device 100 may extract an A-C join as a first common subquery from the updated baseline subplan 741. The graph extraction device 100 may generate a first subplan on the basis of the extracted first common subquery and generate the second subplan 742 including the join sharing-outer join (JS-OJ) query and the second subplan 743 including the join sharing-materialized view (JS-MV) query on the basis of the generated first subplan. The graph extraction device 100 may generate a second cost model 740 including the baseline cost for the baseline subplan 741 and the costs required for executing the second subplans 742 and 743 and perform an operation of determining the second subplan with the lowest cost as the second optimal plan 735.

Referring to FIG. 7, the graph extraction device 100 may determine the second optimal plan 735 as the graph extraction query set 751 by performing the operation 750 of determining the determined optimal plan as the graph extraction query set 751. Accordingly, the graph extraction device 100 can reduce the cost and time required for extracting a graph by determining the second optimal plan 735 that is more optimized than the first optimal plan 715 as the graph extraction query set 751.

In some cases, until the second optimal plan 735 derived through the reperforming operation 730 becomes identical to the baseline subplan 741, the graph extraction device 100 may repeat the operation 730 of reperforming the operation of updating the second optimal plan 735 with the baseline subplan 741 and the operation of determining the second optimal plan 735. In addition, the graph extraction device 100 may further perform an operation of determining the second optimal plan 735 as the graph extraction query set 751 that is the optimal plan when the baseline subplan 741 is identical to the second optimal plan 735. For example, since a cost (650) required for executing the second optimal plan 735 is not equal to the baseline cost (700) for the baseline subplan 741, the graph extraction device 100 may further perform the operation of updating the second optimal plan 735 with the baseline subplan 741 and an operation of reperforming the operation of extracting the first common subqueries, the operation of generating the one or more first subplans, the operation of generating the plurality of second subplans 742 and 743, and the operation of determining the second subplan with the lowest cost as the second optimal plan 735, on the basis of the updated baseline subplan 741. Subsequently, when the baseline subplan 741 is determined as the second optimal plan 735 and the baseline cost for the baseline subplan 741 becomes equal to a cost required for executing the second optimal plan 735, there is no method of optimizing the baseline subplan 741 through the join sharing-outer join (JS-OJ) query and the join sharing-materialized view (JS-MV) query, and thus the second optimal plan 735 may be determined as the graph extraction query set 751.

Accordingly, the graph extraction device 100 according to the embodiment of the present disclosure may determine a subquery with the lowest cost as the graph extraction query set 751 among subqueries of all cases based on the one or more join queries 711 included in the received query. Therefore, the graph extraction device 100 can improve efficiency in graph extraction and graph analysis by extracting a graph at the lowest cost.

Also, the graph extraction device 100 can effectively reduce a computational cost for a join query by performing a hybrid query optimization operation including both a query optimization operation based on a join sharing-outer join (JS-OJ) query and a query optimization operation based on a join sharing-materialized view (JS-MV) query. Even when a cost required for computing a join sharing-outer join (JS-OJ) query or a join sharing-materialized view (JS-MV) query increases beyond the baseline cost or decreases slightly, the graph extraction device 100 can derive an optimized plan by performing a hybrid query optimization operation of selectively performing an optimization operation employing a join sharing-outer join query(JS-OJ) and a query optimization operation employing a join sharing-materialized view query (JS-MV) on the basis of costs. In other words, the graph extraction device 100 can improve the efficiency of a query optimization operation by complementarily performing an optimization operation employing a join sharing-outer join (JS-OJ) query and a query optimization operation employing a join sharing-materialized view (JS-MV) query.

FIG. is 8 an illustrative diagram explaining an operation of extracting a graph according to the embodiment of the present disclosure.

Referring to FIG. 8, the graph extraction device 100 may perform an operation of extracting a graph 835 corresponding to a graph extraction query set 811 from an RDB 812. Specifically, the graph extraction device 100 may perform an operation 810 of processing the graph extraction query set 811 within the RDB 812, an operation 820 of extracting a plurality of vertices 826 and 828 and one or more edges 827 and 829 from computation result tables 821 and 822 of the graph extraction query set 811, and an operation 830 of converting the plurality of extracted vertices 826 and 828 and the one or more extracted edges 827 and 829 into a graph 835.

The operation 810 of processing the graph extraction query set 811 within the RDB 812 may include an operation of processing join queries included in the graph extraction query set 811 on the basis of tables and materialized views V stored in the RDB 812. For example, based on a GetDisc join query of the graph extraction query set 811, the graph extraction device 100 may perform an inner join operation on a promotion (P) table and an item (I) table of the materialized views V and the RDB 812 and output the computation result table 821 of the GetDisc join query. In some cases, when the graph extraction query set 811 does not include the materialized views V, the graph extraction device 100 may output a computation result table of the graph extraction query set 811 by performing an inner join or an outer join of tables in the RDB 812.

The operation 820 of extracting the plurality of vertices 826 and 828 and the one or more edges 827 and 829 from the computation result tables 821 and 822 of the graph extraction query set 811 may include an operation of extracting the edges 827 and 829 corresponding to the types of join queries included in the graph extraction query set 811 and an operation of extracting the vertices 826 and 828 generated from the computation result tables 821 and 822. More specifically, the graph extraction device 100 may extract a plurality of vertices and attributes of the plurality of vertices from the computation result tables 821 and 822 on the basis of the vertices and edges of the graph defined in the graph model 340 of FIG. 3. For example, the graph extraction device 100 may perform an operation of extracting the GetDisc edge 827 corresponding to a GetDisc join query included in the graph extraction query set 811 and an operation of extracting the plurality of vertices 826 derived from the computation result table 821.

The operation 830 of converting the plurality of extracted vertices 826 and 828 and the one or more extracted edges 827 and 829 into the graph 835 may include an operation of displaying the extracted vertices 826 and 828 as different vertices in accordance with labels and an operation of displaying the extracted edges 827 and 829 as different edges in accordance with labels.

Referring to FIG. 8, the types of join queries included in the graph extraction query set 811 may include the types of extracted edges 827 and 829. In other words, the types of edges 827 and 829 included in the graph 835 may be defined in accordance with the types of join queries included in the graph extraction query set 811. In some cases, the number of types of extracted edges 827 and 829 may be equal to the number of join queries included in the graph extraction query set 811. For example, when the types of join queries included in the graph extraction query set 811 are two types including GetDisc and CoPur, the graph 835 may be solely composed of GetDisc edges or CoPur edges or may be composed of a GetDisc edge and a CoPur edge.

Accordingly, the graph extraction device 100 according to the embodiment of the present disclosure can accurately extract a user-intended graph solely composed of vertices and edges queried by the input query by performing an operation of extracting the edges 827 and 829 corresponding to the types of join queries. Also, the graph extraction device 100 can accurately generate a user-intended graph even with various edge patterns such as a chain structure, a star structure, or a cyclic structure by generating a graph on the basis of the vertices and edges defined in the graph model 340, the edges 827 and 829 corresponding to the types of join queries, and the vertices 826 and 828 extracted from the computation result tables 821 and 822. Therefore, the graph extraction device 100 can improve efficiency in analysis based on the extracted graph 102 and reduce the time and cost required for graph analysis by omitting unnecessary vertices and edges and extracting the graph 102 solely composed of edges defined in the query 101.

As described above, the graph extraction device 100 according to the embodiment of the present disclosure can reduce the time and cost required for extracting a final graph for graph analysis by extracting a user-intended graph at a time. The case of extracting a graph including virtual vertices and virtual edges from an RDB additionally requires a postprocessing operation of accurately generating a user-intended graph, which may increase the time and cost required for extracting a final graph for graph analysis. On the contrary, the graph extraction device 100 according to the embodiment of the present disclosure can reduce the time and cost for extracting and analyzing a graph by extracting a user-intended graph at a time with no additional postprocessing operation.

Also, the graph extraction device 100 according to the embodiment of the present disclosure can extract a graph including at least one of a star edge shape and a cyclic edge shape by processing the query 101 including at least one of a star query and a cyclic query and extracting the graph 102 corresponding to the query 101. Accordingly, the graph extraction device 100 can extend the application range of graph analysis based on an extracted graph by supporting various types of queries and graph structures.

Also, the graph extraction device 100 according to the embodiment of the present disclosure can reduce the time and cost required for extracting the graph 102 by optimizing at least one join query. When each of a plurality of received join queries is processed without any change, the plurality of join queries may include many joins or complex joins including N-to-N joins between foreign keys, dramatically increasing the time and cost required for extracting the graph 102. On the contrary, the graph extraction device 100 according to the embodiment of the present disclosure can reduce a query execution time and a query execution cost required for extracting the graph 102 by simplifying and optimizing received join queries on the basis of common subqueries.

Also, the graph extraction device 100 according to the embodiment of the present disclosure can prevent the interference between join operations by connecting the second common subquery 435 to non-common subqueries through an outer join. Therefore, the graph extraction device 100 can calculate results identical to those obtained by individually processing a plurality of join queries, by setting the second common subquery 435 as an outer table and performing an outer join on the second common subquery 435 and the non-common subqueries. Accordingly, the graph extraction device 100 can reduce the time and cost required for computing the plurality of join queries 410 while calculating results identical to those obtained by individually computing the plurality of join queries 410.

Also, the graph extraction device 100 according to the embodiment of the present disclosure can reduce unnecessary computations by pre-storing, as a materialized view, a computation result of a common subquery that is repeatedly executed. Therefore, the graph extraction device 100 can reduce the load on the graph extraction device 100 and a DB server by reducing the usage of the CPU and memory used for unnecessary computations.

Also, the graph extraction device 100 according to the embodiment of the present disclosure can derive the first optimal plan 715 with the lowest cost among various subplans by generating the first cost model 720 including the baseline cost for the baseline subplan 741 and cost information of each of the second subplans 722, 723, 724, and 725 and comparing the cost information with each other. Therefore, the graph extraction device 100 can reduce the cost required for graph extraction by always deriving an optimized plan that requires the lowest cost. In some cases, even when a cost required for computing a join sharing-outer join (JS-OJ) query or a join sharing-materialized view (JS-MV) query increases beyond the baseline cost or decreases slightly, the graph extraction device 100 can improve the efficiency of a query optimization operation by deriving an optimized plan requiring the lowest cost.

Also, the graph extraction device 100 according to the embodiment of the present disclosure can effectively reduce a computational cost for a join query by performing a hybrid query optimization operation including both a query optimization operation based on a join sharing-outer join (JS-OJ) query and a query optimization operation based on a join sharing-materialized view (JS-MV) query. Even when a cost required for computing a join sharing-outer join (JS-OJ) query or a join sharing-materialized view (JS-MV) query increases beyond the baseline cost or decreases slightly, the graph extraction device 100 can derive an optimized plan by performing a hybrid query optimization operation of selectively performing an optimization operation employing a join sharing-outer join query (JS-OJ) and a query optimization operation employing a join sharing-materialized view (JS-MV) query on the basis of costs. In other words, the graph extraction device 100 can improve the efficiency of a query optimization operation by complementarily performing an optimization operation based on a join sharing-outer join (JS-OJ) query and a query optimization operation based on a join sharing-materialized view (JS-MV) query.

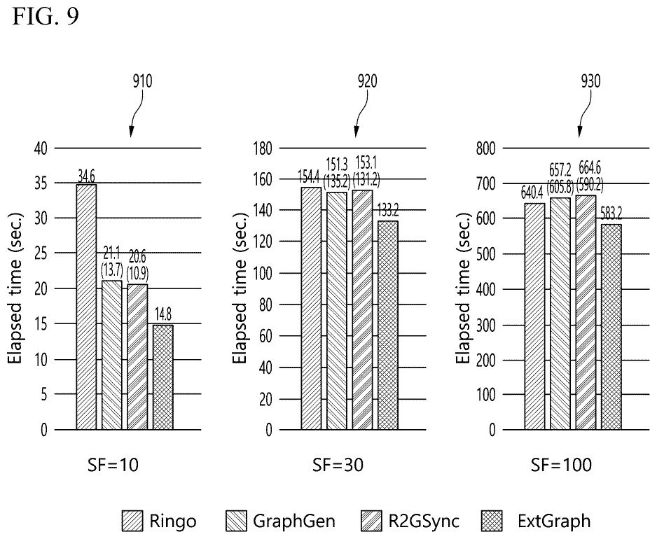

FIG. 9 is a set of graphs illustrating the performance of the graph extraction device according to the embodiment of the present disclosure on the basis of a recommendation system model of a transaction processing performance council decision support (TPC-DS) dataset.

Referring to FIG. 9, the graph extraction device according to the embodiment of the present disclosure corresponds to a graph extraction device that performs an ExtGraph method (hereinafter “ExtGraph graph extraction device”). Accordingly, the performance of the graph extraction device 100 may be checked from the graph extraction performance of the ExtGraph graph extraction device on the basis of the recommendation system model of the TPC-DS dataset. Specifically, the graph extraction performance of the ExtGraph graph extraction device may be compared with the graph extraction performance of Ringo, GraphGen, and R2GSync graph extraction devices on the basis of the recommendation system model of the TPC-DS dataset.

Experimental environments of the graph extraction devices were set to be identical. Specifically, each graph extraction device ran on a single server with the following specifications: two 16-core 3.0 GHz CPUs, 1 TB of memory, and a 14-TB hard disk. The operating system (OS) was Ubuntu 18.04.4, and the server was implemented on the basis of PostgreSQL 14.4 which is a fundamental system. To ensure fairness in comparison, all experiments for the graph extraction devices were implemented in the same environment using PostgreSQL extensions.

The ExtGraph graph extraction device and the Ringo, GraphGen, and R2GSync graph extraction devices are all join workload-based graph extraction devices that extract graphs on the basis of join queries. The GraphGen and R2GSync graph extraction devices cannot extract a user-intended graph at a time but extract graphs including virtual vertices and virtual edges. Therefore, the times required for converting output graphs into a user-intended graph are also included in the processing times of the GraphGen and R2GSync graph extraction devices. The times required for converting graphs output by the GraphGen and R2GSync graph extraction devices into a user-intended graph are shown in the parentheses of graphs 910, 920, and 930.

Referring to FIG. 9, the first graph 910, the second graph 920, and the third graph 930 show times required for extracting a user-intended graph from a TPC-DS dataset with a scale factor (SF) equal to 10, a TPC-DS dataset with an SF equal to 30, and a TPC-DS dataset with an SF equal to 100, respectively. For example, the TPC-DS datasets may be data warehouse benchmark datasets including sales data based on stores, catalogs, and the web. The first to third graphs 910 to 930 show times required for extracting a graph for a recommendation system from the TPC-DS datasets. Specifically, the first to third graphs 910 to 930 may show the times required for each of the graph extraction devices to extract a user-intended graph including relationship (Co-pur) edges between customers who purchase the same product, relationship (Same-pro) edges between customers who watch the same promotion, and relationship (Buy) edges between customers and products purchased by the customers from store sales data of the TPC-DS datasets.

Referring to FIG. 9, it is possible to see that the ExtGraph graph extraction device exhibits the highest performance all across the first graph 910, the second graph 920, and the third graph 930. Specifically, in the first graph 910 with an SF equal to 10, the ExtGraph graph extraction device is 2.34 times faster than the Ringo graph extraction device and up to 30% faster than the GraphGen and R2GSync graph extraction devices. Also in the second graph 920 and the third graph 930, the ExtGraph graph extraction device exhibits the shortest extraction time in relation to Ringo, GraphGen, and R2GSync graph extraction devices. In the third graph 930 based on a mass dataset with an SF equal to 100, the ExtGraph graph extraction device exhibits 10% or more performance improvement compared to the Ringo graph extraction device. The GraphGen and R2GSync graph extraction devices that generate a graph including virtual vertices and virtual edges and then convert the graph into a user-intended graph involve additional costs during a postprocessing operation. On the contrary, the ExtGraph graph extraction device extracts a user-intended graph at a time with no additional postprocessing operation, thus showing better performance than all the devices (Ringo, GraphGen, and R2GSync) to be compared.

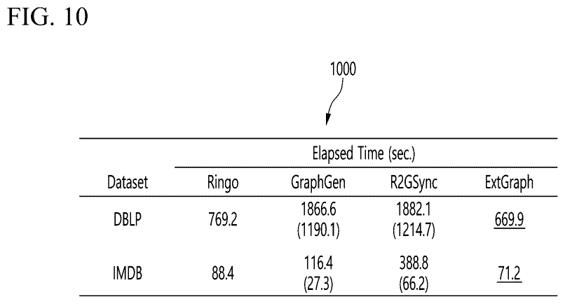

FIG. 10 is a table illustrating the performance of the graph extraction device according to the embodiment of the present disclosure on the basis of a database systems and logic programming (DBLP) dataset and an Internet movie database (IMDB) dataset.

Referring to FIG. 10, a performance measurement experiment for the ExtGraph graph extraction device according to the present embodiment may be configured to measure the time taken by each graph extraction device to extract a graph from the DBLP dataset and extract a graph from the IMDB dataset as shown in FIG. 9. In other words, a performance measurement result table 1000 of FIG. 10 shows measurement results acquired in substantially the same experimental environment using the same devices to be compared as those shown in the first to third graphs 910 to 930. Accordingly, the duplicate description of a configurations that is substantially identical to that of the performance measurement experiment of the ExtGraph graph extraction device will be omitted.

Referring to FIG. 10, the performance measurement result table 1000 shows the time taken for each graph extraction device to extract a graph including relationship (Co-Author) edges between people who co-authored papers and relationship (Auto-Edit) edges between authors and editors who edit the corresponding papers from the DBLP dataset and the time taken for each graph extraction device to extract a graph including relationship (Wri-Dir) edges between writers and directors who work on the same movie and relationship (Act-Dir) edges between actors and directors who work on the same movie from the IMDB dataset.

Referring to FIG. 10, the ExtGraph graph extraction device consistently outperforms all other devices in both graph extraction performance on the DBLP dataset and graph extraction performance on the IMDB dataset. In particular, the ExtGraph graph extraction device extracts graphs from the DBLP dataset approximately 2.79 times faster than the GraphGen graph extraction device and achieves a speed approximately 5.46 times faster than the R2GSync from the IMDB dataset, exhibiting significant performance improvement. In an experiment for evaluating graph extraction performance on the basis of the IMDB dataset, the R2GSync graph extraction device shows the lowest performance. This is because the R2GSync graph extraction device that decomposes join queries into smaller queries results in performance degradation. On the contrary, the ExtGraph graph extraction device can prevent performance degradation in any case by selecting an optimal plan through comparison between a baseline subplan and second subplans. Also, the ExtGraph graph extraction device selectively performs a query optimization operation by utilizing a join sharing-outer join (JS-OJ) query and a join sharing-materialized view (JS-MV) query. Accordingly, even when one optimalization operation is inefficient for a specific graph model, the ExtGraph graph extraction device can complementarily perform the other optimization operation. Consequently, the ExtGraph graph extraction device can prevent overall performance degradation and maintain consistently high performance compared to other graph extraction devices.

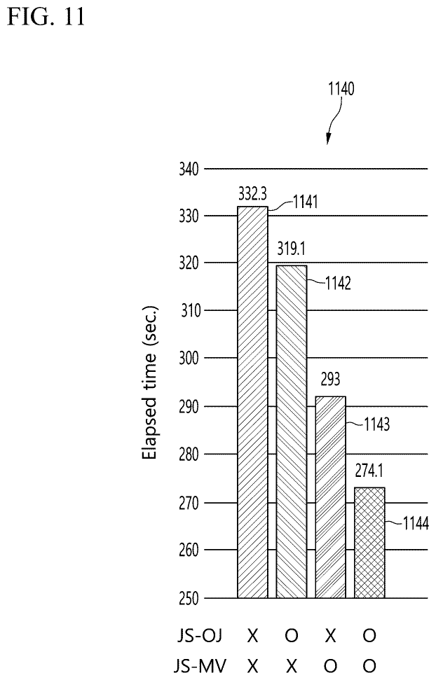

FIG. 11 is a graph illustrating stage-specific performance of the graph extraction device according to the embodiment of the present disclosure based on a query optimization operation.

Referring to FIG. 11, a performance measurement experiment for the ExtGraph graph extraction device according to the present embodiment was configured to measure the time required for extracting a graph for a recommendation system from catalog-based sales data of a TPC-DS dataset and extracting a graph for fraud detection from store-based sales data of a TPC-DS dataset. Specifically, the performance measurement experiment for the ExtGraph graph extraction device according to the present embodiment was configured to measure the time required for extracting a graph including four types of edges Sell, Buy, Co-pur, and Same-pro from catalog-based sales data of a TPC-DS dataset with an SF equal to 100 and store-based sales data of a TPC-DS dataset with an SF equal to 100.

Referring to FIG. 11, a fourth graph 1140 shows the times taken to extract a graph for four join queries including Sell, Buy, Co-pur, and Same-pro in accordance with a baseline plan 1141 in which the ExtGraph graph extraction device does not perform any query optimization operation, an outer join plan 1142 in which the ExtGraph graph extraction device performs an optimization operation by utilizing a join sharing-outer join (JS-OJ) query, a materialized view plan 1143 in which the ExtGraph graph extraction device performs an optimization operation by utilizing a join sharing-materialized view (JS-MV) query, and a hybrid plan 1144 in which the ExtGraph graph extraction device performs an optimization operation by utilizing both a join sharing-outer join (JS-OJ) query and join sharing-materialized view (JS-MV) query.

Referring to FIG. 11, in the fourth graph 1140, the outer join plan 1142 shows a performance improvement of approximately 4% speed increase compared to the baseline plan 1141, and the materialized view plan 1143 achieves a performance improvement of approximately 13% speed increase compared to the baseline plan 1141, indicating that the materialized view plan 1143 shows a greater performance improvement compared to the outer join plan 1142. Also, the hybrid plan 1144 shows approximately 21% improved performance compared to the baseline plan 1141, exhibiting about 7% higher performance than the materialized view plan 1143. Accordingly, the ExtGraph graph extraction device performs a hybrid query optimization operation of updating a determined optimal plan with a baseline subplan and generating an optimal plan again on the basis of the updated baseline subplan, thereby providing a greater performance improvement than an operation of separately performing an optimization operation employing a join sharing-outer join (JS-OJ) query and an optimization operation employing a join sharing-materialized view (JS-MV) query.

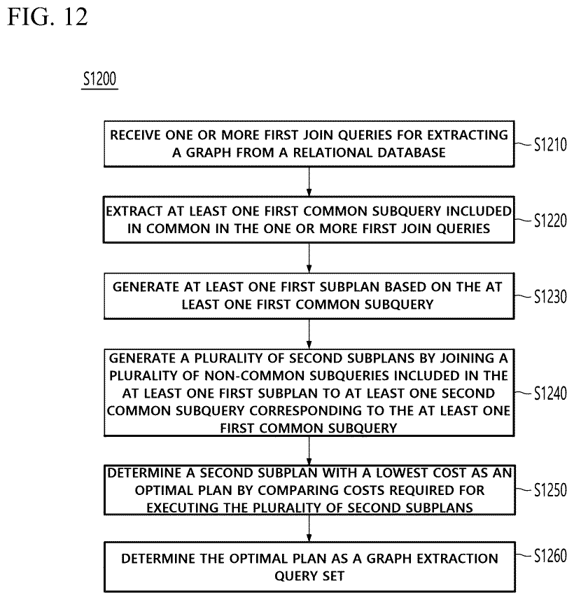

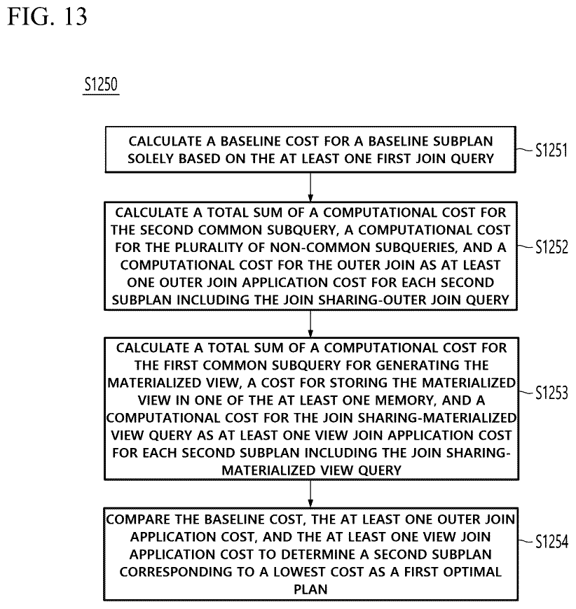

FIG. 12 is a flowchart illustrating a graph extraction method according to an embodiment of the present disclosure. FIG. 13 is a flowchart illustrating an optimal plan determination method according to an embodiment of the present disclosure.

Referring to FIG. 12, a graph extraction method S1200 is a method of extracting a graph by a graph extraction device including at least one memory including a plurality of instructions and at least one processor electrically connected to the at least one memory and configured to execute the plurality of instructions, the method including an operation S1210 of receiving one or more first join queries for extracting a graph from an RDB, an operation S1220 of extracting at least one first common subquery included in common in the one or more first join queries, an operation S1230 of generating at least one first subplan on the basis of the at least one first common subquery, an operation S1240 of generating a plurality of second subplans by joining a plurality of non-common subqueries included in the at least one first subplan to at least one second common subquery corresponding to the at least one first common subquery, an operation S1250 of determining a second subplan with the lowest cost as an optimal plan by comparing costs required for executing the plurality of second subplans, and an operation S1260 of determining the optimal plan as a graph extraction query set.

In the operation S1240 of generating the plurality of second subplans, the at least one second common subquery may include the at least one first common subquery and a materialized view storing a computation result of the at least one first common subquery, and the plurality of second subplans may include a join sharing-outer join query acquired by performing an outer join on the second common subquery and the plurality of non-common subqueries and a join sharing-materialized view query acquired by performing an inner join on the materialized view and the plurality of non-common subqueries.

In the operation S1240 of generating the plurality of second subplans, the graph extraction device may further perform an operation of decomposing the at least one first subplan into the first common subquery and the non-common subqueries and an operation of setting the second common subquery corresponding to the first common subquery as an outer table and performing an outer join on the non-common subqueries and the second common subquery to generate the join sharing-outer join query.

In the operation S1240 of generating the plurality of second subplans, the graph extraction device may further perform an operation of generating the computation result of the first common subquery as the materialized view, an operation of electrically storing the materialized view in the at least one memory, and an operation of generating the join sharing-materialized view query by performing an inner join on the materialized view and the plurality of non-common subqueries.

Referring to FIGS. 12 and 13, in the operation S1250 of determining the second subplan with the lowest cost as the optimal plan, the graph extraction device may further perform an operation S1251 of calculating a baseline cost for a baseline subplan solely on the basis of the one or more first join queries, an operation S1252 of calculating a total sum of a computational cost for the second common subquery, a computational cost for the plurality of non-common subqueries, and a computational cost for the outer join as at least one outer join application cost for each second subplan including the join sharing-outer join query, an operation S1253 of calculating a total sum of a computational cost for the first common subquery for generating the materialized view, a cost for storing the materialized view in one of the at least one memory, and a computational cost for the join sharing-materialized view query as at least one view join application cost for each second subplan including the join-sharing materialized view query, and an operation S1254 of comparing the baseline cost, the at least one outer join application cost, and the at least one view join application cost to determine a second subplan corresponding to the lowest cost as a first optimal plan.

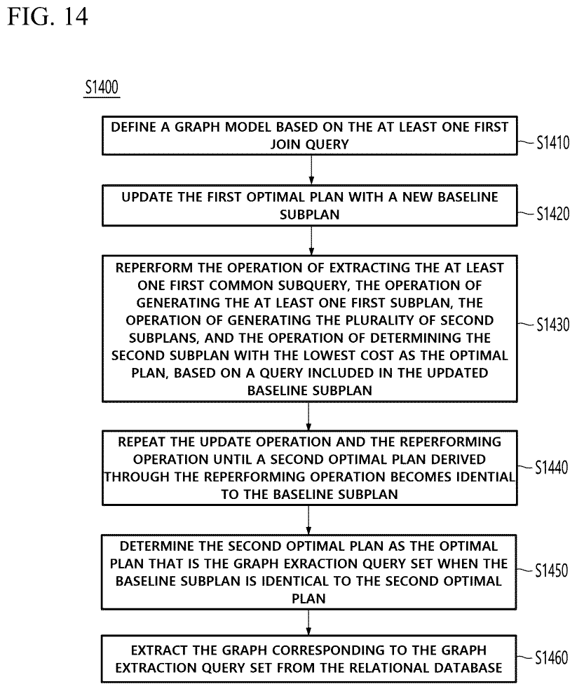

FIG. 14 is a flowchart illustrating additional operations of a graph extraction method according to another embodiment of the present disclosure.

Referring to FIG. 14, in addition to the configuration of the graph extraction method S1200 of FIG. 12, a graph extraction method S1400 according to the present embodiment may further include an operation S1410 in which the graph extraction device defines a graph model on the basis of the one or more first join queries, an operation S1420 in which the graph extraction device updates the first optimal plan with a new baseline subplan, an operation S1430 in which the graph extraction device reperforms the operation of extracting the at least one first common subquery, the operation of generating the at least one first subplan, the operation of generating the plurality of second subplans, and the operation of determining the second subplan with the lowest cost as the optimal plan, on the basis of a query included in the updated baseline subplan, an operation S1440 in which the graph extraction device repeats the update operation and the reperforming operation until a second optimal plan derived through the reperforming operation becomes identical to the baseline subplan, an operation S1450 in which the graph extraction device determines the second optimal plan as the optimal plan that is the graph extraction query set when the baseline subplan is identical to the second optimal plan, and an operation S1460 in which the graph extraction device extracts a graph corresponding to the graph extraction query set from the RDB. Accordingly, the duplicate description of a configuration that is substantially identical to that of the graph extraction method S1200 of FIG. 12 will be omitted.

The operation S1410 of defining the graph model may be performed after the operation S1210 of receiving the one or more first join queries in FIG. 12 and before the operation S1460 of extracting the graph in FIG. 14. For example, the operation S1410 of defining the graph model may be performed after the operation S1210 of receiving the one or more first join queries in FIG. 12 and before the operation S1220 of extracting the at least one first common subquery in FIG. 12. In some cases, the operation S1410 of defining the graph model may be performed after the operation S1260 of determining the optimal plan as the graph extraction query set in FIG. 12 or the operation S1450 of determining the second optimal plan as the optimal plan that is the graph extraction query set in FIG. 14. According to the graph extraction method S1400, the graph extraction device may define vertices and edges required for graph extraction before an operation of optimizing a query by performing the operation S1410 of defining the graph model after the operation S1210 of receiving the one or more first join queries in FIG. 12 and before the operation S1220 of extracting the at least one first common subquery in FIG. 12. Therefore, in the graph extraction method S1400 according to the embodiment of the present disclosure, the graph extraction device can prevent unnecessary computations and reduce the load on an RDB by selecting tables and attributes of vertices and edges required for graph extraction before the operation of optimizing a query.

In the operation S1410 of defining the graph model, the graph model may include information on a plurality of vertices and one or more edges defined by the one or more first join queries.

In the operation S1460 of extracting the graph, the graph extraction device may further perform an operation of computing the graph extraction query set from the RDB, an operation of extracting the plurality of vertices and the one or more edges from a computation result table of the graph extraction query set, and an operation of converting the plurality of extracted vertices and the one or more extracted edges into the graph. The number of types of one or more edges may be equal to the number of one or more first join queries, and the graph may include one or more edges having a pattern of a star structure or a cyclic structure.

In the present specification, each block may represent a part of a module, a segment, or code including one or more executable instructions for executing a specific logical function(s). It is also to be noted that, in some alternative embodiments, functions described in blocks may occur out of order. For example, two blocks shown in succession may actually be executed substantially concurrently, or the blocks or operations may sometimes be executed in a reverse order depending on the corresponding function.

Operations of the method or algorithm described in connection with the embodiments disclosed herein may be directly implemented with a hardware or software module executed by a processor or a combination of hardware and software modules. For example, the device, method, and components described in the embodiments may be implemented using a general-purpose computer or a special-purpose computer such as a processor, a controller, an arithmetic logical unit (ALU), a digital signal processor, a microcomputer, a field programmable gate array (FPGA), a programmable logic unit (PLU), a microprocessor, or any device that may execute instructions and respond. A processing device may execute an OS and a software application running on the OS. Further, the processing device may access, store, manipulate, process, and generate data in response to execution of software. Although it may be described that a single processing device is used for convenience of understanding, those of ordinary skill in the art should appreciate that the processing device may include a plurality of processing elements and/or a plurality of types of processing elements. For example, the processing device may include a plurality of processors or one processor and one controller. Also, the processing device may have a different processing configuration such as a parallel processor.

Software may include computer programs, code, instructions, or one or more combinations thereof and may configure a processing device to operate in a desired manner or may independently or collectively instruct the processing device. Software and/or data may be permanently or temporarily embodied in any type of machine, component, physical device, virtual equipment, computer storage media or device, or transmitted signal wave to be interpreted by the processing device or provide instructions or data to the processing device. Software may be distributed across computer systems connected via a network and may be stored or executed in a distributed manner. Computer programs, software and data may be recorded on a computer-readable storage medium.

A method according to an embodiment may be implemented in the form of program instructions that are executable by various computing devices and recorded on a computer-readable recording medium. The computer-readable recording medium may store program instructions, data files, data structures, etc., individually or in combination, and the program instructions recorded on the medium may be those specially designed and configured for the embodiment or those known and available to those skilled in the art of computer software. Examples of the computer-readable recording medium include magnetic media such as a hard disk, a floppy disk, and magnetic tape, optical media such as a compact disc (CD) read-only memory (ROM) and a digital versatile disc (DVD), magneto-optical media such as a floptical disk, and hardware devices specially configured to store and execute program instructions such as a ROM, a random access memory (RAM), a flash memory, a register, any other form of storage medium known to the art, and the like. An exemplary storage medium may be coupled to a processor, and the processor may read information from the storage medium and write information on the storage medium. Alternatively, the storage medium may be integrated with the processor. The processor and the storage medium may reside in an ASIC. The ASIC may reside in a user terminal. Alternatively, the processor and the storage medium may reside as individual components in a user terminal. Examples of the program instructions include machine code such as those produced by a compiler, and high-level code that is executable by a computer using an interpreter or the like.

The above-described hardware devices may be configured to operate as one or more software modules to perform operations of an embodiment, or vice versa.

According to one of the solutions of the present disclosure, a graph extraction device extracts a graph composed solely of vertices and edges defined by a query, thereby improving the efficiency of analysis based on the extracted graph and reducing the time and cost required for graph analysis.

According to one of the solutions of the present disclosure, a graph extraction device extracts a user-intended graph at a time, and thus it is possible to omit an additional postprocessing operation of converting an extracted graph into a user-intended graph.

According to one of the solutions of the present disclosure, a graph extraction device extracts a user-intended graph at a time with no additional postprocessing operation, thereby reducing the time and cost for extracting and analyzing a graph.

According to one of the solutions of the present disclosure, a graph extraction device supports various types of queries and graph structures including a star edge shape and a cyclic edge shape, and thus it is possible to extend the application range of graph analysis based on an extracted graph.

According to one of the solutions of the present disclosure, a graph extraction device simplifies and optimizes a received join query on the basis of a common subquery, thereby reducing the query operation time and query operation cost required for graph extraction.

According to one of the solutions of the present disclosure, a graph extraction device sets a common subquery as an outer table and performs an outer join on the common subquery and a non-common subquery. Accordingly, while calculating results identical to those obtained by individually computing a plurality of join queries, it is possible to reduce the time and cost required for processing the queries.

According to one of the solutions of the present disclosure, a graph extraction device can reduce unnecessary computations by pre-storing, as a materialized view, a computation result of a common subquery that is repeatedly executed.

According to one of the solutions of the present disclosure, a graph extraction device can keep query optimization performance consistent and high by performing a hybrid query optimization operation including both a query optimization operation based on a join sharing-outer join query and a query optimization operation based on a join sharing-materialized view query.

Effects of the present disclosure are not limited to those described above, and other effects that have not been described above will be clearly understood by those skilled in the technical field to which the present disclosure pertains from the above description.

Although embodiments of the present disclosure have been described in detail with reference to the accompanying drawings, the present disclosure is not necessarily limited these embodiments and may be variously modified without departing from the technical spirit of the present disclosure. Therefore, the embodiments of the present disclosure are not intended to limit the technical spirit of the present disclosure but are for the purpose of illustration, and the scope of the technical spirit of the present disclosure is not limited by the embodiments. Therefore, the above-described embodiments should be construed as not limiting but illustrative in all aspects. The scope of the present disclosure should be interpreted on the basis of the following claims, and all technical concepts within a range equivalent thereto should be interpreted as falling within the scope of the present disclosure.

What is claimed is:

1. A device for extracting a graph, comprising:
at least one memory including a plurality of instructions; and
at least one processor electrically connected to the at least one memory and configured to execute the plurality of instructions,
wherein, when the plurality of instructions are executed by the at least one processor, the at least one processor performs a plurality of operations including:
receiving one or more first join queries for extracting a graph from a relational database (RDB);
extracting at least one first common subquery included in common in the one or more first join queries;
generating at least one first subplan on the basis of the at least one first common subquery;
generating a plurality of second subplans by joining a plurality of non-common subqueries included in the at least one first subplan to at least one second common subquery corresponding to the at least one first common subquery;
determining a second subplan with a lowest cost as an optimal plan by comparing costs required for executing the plurality of second subplans; and
determining the optimal plan as a graph extraction query set.

2. The device of claim 1, wherein the at least one second common subquery include the at least one first common subquery and a materialized view storing a computation result of the at least one first common subquery, and
the plurality of second subplans include a join sharing-outer join query acquired by performing an outer join on the second common subquery and the plurality of non-common subqueries and a join sharing-materialized view query acquired by performing an inner join on the materialized view and the plurality of non-common subqueries.

3. The device of claim 2, wherein the generating of the plurality of second subplans comprises:
decomposing the at least one first subplan into the first common subquery and the non-common subqueries; and
setting the second common subquery corresponding to the first common subquery as an outer table and performing an outer join on the non-common subqueries and the second common subquery to generate the join sharing-outer join query.

4. The device of claim 2, wherein the generating of the plurality of second subplans comprises:
generating the computation result of the first common subquery as the materialized view;
electrically storing the materialized view in the at least one memory; and
generating the join sharing-materialized view query by performing an inner join on the materialized view and the plurality of non-common subqueries.

5. The device of claim 2, wherein the determining of the second subplan with the lowest cost as the optimal plan comprises:
calculating a baseline cost for a baseline subplan solely on the basis of the one or more first join queries;
calculating a total sum of a computational cost for the second common subquery, a computational cost for the plurality of non-common subqueries, and a computational cost for the outer join as at least one outer join application cost for each of the second subplans;
calculating a total sum of a computational cost for the first common subquery for generating the materialized view, a cost for storing the materialized view in one of the at least one memory, and a computational cost for the join sharing-materialized view query as at least one view join application cost for each second subplan; and
comparing the baseline cost, the at least one outer join application cost, and the at least one view join application cost to determine a second subplan corresponding to a lowest cost as a first optimal plan.

6. The device of claim 5, wherein the plurality of operations further include:
updating the first optimal plan with a new baseline subplan;
reperforming the extracting of the at least one first common subquery, the generating of the at least one first subplan, the generating of the plurality of second subplans, and the determining of the second subplan with the lowest cost as the optimal plan, on the basis of a query included in the updated baseline subplan;
repeating the updating and the reperforming until a second optimal plan derived through the reperforming becomes identical to the baseline subplan; and
determining the second optimal plan as the optimal plan that is the graph extraction query set when the baseline subplan is identical to the second optimal plan.

7. The device of claim 1, wherein the plurality of operations further include:
defining a graph model on the basis of the one or more first join queries; and
extracting the graph corresponding to the graph extraction query set from the RDB,
wherein the graph model includes information on a plurality of vertices and one or more edges defined by the one or more first join queries.

8. The device of claim 7, wherein the extracting of the graph comprises:
computing the graph extraction query set from the RDB;
extracting the plurality of vertices and the one or more edges from a computation result table of the graph extraction query set; and
converting the plurality of extracted vertices and the one or more extracted edges into the graph,
wherein the number of types of one or more edges is equal to the number of one or more first join queries.

9. The device of claim, 8, wherein the graph includes one or more edges having a pattern of a star structure or a cyclic structure.

10. A method of extracting a graph by a graph extraction device including at least one memory including a plurality of instructions and at least one processor electrically connected to the at least one memory and configured to execute the plurality of instructions, the method comprising:
receiving one or more first join queries for extracting a graph from a relational database (RDB);
extracting at least one first common subquery included in common in the one or more first join queries;
generating at least one first subplan on the basis of the at least one first common subquery;
generating a plurality of second subplans by joining a plurality of non-common subqueries included in the at least one first subplan to at least one second common subquery corresponding to the at least one first common subquery;
determining a second subplan with a lowest cost as an optimal plan by comparing costs required for executing the plurality of second subplans; and
determining the optimal plan as a graph extraction query set.

11. The method of claim 10, wherein the at least one second common subquery includes the at least one first common subquery and a materialized view storing a computation result of the at least one first common subquery, and
the plurality of second subplans include a join sharing-outer join query acquired by performing an outer join on the second common subquery and the plurality of non-common subqueries and a join sharing-materialized view query acquired by performing an inner join on the materialized view and the plurality of non-common subqueries.

12. The method of claim 11, wherein the generating of the plurality of second subplans comprises:
decomposing the at least one first subplan into the first common subquery and the non-common subqueries; and
setting the second common subquery corresponding to the first common subquery as an outer table and performing an outer join on the non-common subqueries and the second common subquery to generate the join sharing-outer join query.

13. The method of claim 11, wherein the generating of the plurality of second subplans comprises:
generating the computation result of the first common subquery as the materialized view;
electrically storing the materialized view in the at least one memory; and
generating the join sharing-materialized view query by performing an inner join on the materialized view and the plurality of non-common subqueries.

14. The method of claim 11, wherein the determining of the second subplan with the lowest cost as the optimal plan comprises:
calculating a baseline cost for a baseline subplan solely on the basis of the one or more first join queries;
calculating a total sum of a computational cost for the second common subquery, a computational cost for the plurality of non-common subqueries, and a computational cost for the outer join as at least one outer join application cost for each second subplan including the join sharing-outer join query;
calculating a total sum of a computational cost for the first common subquery for generating the materialized view, a cost for storing the materialized view in one of the at least one memory, and a computational cost for the join sharing-materialized view query as at least one view join application cost for each second subplan including the join-sharing materialized view query; and
comparing the baseline cost, the at least one outer join application cost, and the at least one view join application cost to determine a second subplan corresponding to a lowest cost as a first optimal plan.

15. The method of claim 14, further comprising:
updating the first optimal plan with a new baseline subplan;
reperforming the extracting of the at least one first common subquery, the generating of the at least one first subplan, the generating of the plurality of second subplans, and the determining of the second subplan with the lowest cost as the optimal plan, on the basis of a query included in the updated baseline subplan;
repeating the updating and the reperforming until a second optimal plan derived through the reperforming becomes identical to the baseline subplan; and
determining the second optimal plan as the optimal plan that is the graph extraction query set when the baseline subplan is identical to the second optimal plan.

16. The method of claim 10, further comprising:
defining a graph model on the basis of the one or more first join queries; and
extracting the graph corresponding to the graph extraction query set from the RDB,
wherein the graph model includes information on a plurality of vertices and one or more edges defined by the one or more first join queries.

17. The method of claim 16, wherein the extracting of the graph comprises:
computing the graph extraction query set from the RDB;
extracting the plurality of vertices and the one or more edges from a computation result table of the graph extraction query set; and
converting the plurality of extracted vertices and the one or more extracted edges into the graph,
wherein the number of types of one or more edges is equal to the number of one or more first join queries.

18. The method of claim 17, wherein the graph includes one or more edges having a pattern of a star structure or a cyclic structure.

19. A computer program stored in a computer-readable recording medium to perform the method according to claim 10 in combination with hardware.
